(19) United States
(12) Patent Application Publication
(10) Pub. No.: US 2025/0132826 A1
(43) Pub. Date: Apr. 24, 2025

(54) TERMINAL OPERATION WITH INTERFERENCE AVOIDANCE BETWEEN SATELLITE SYSTEMS USING COMMON SPECTRUM

(71) Applicant: Logos Space Services Inc., Redwood City, CA (US)

(72) Inventors: Milo Steven Medin, Atherton, CA (US); Paul Kolodzy, Falls Church, VA (US)

(21) Appl. No.: 18/919,109

(22) Filed: Oct. 17, 2024

Related U.S. Application Data
(60) Provisional application No. 63/591,596, filed on Oct. 19, 2023.

(51) Int. Cl. H04B 7/185; H01Q 1/28; H04L 69/08

(52) U.S. Cl. CPC H04B 7/18595; H01Q 1/288; H04B 7/18543; H04L 69/08

(57) ABSTRACT

A satellite communication system includes a first frequency reference generator of a terminal, a broadband communication receiving channel, a second frequency reference generator of the terminal, and a broadband communication transmission channel. The first frequency reference generator generates a first frequency reference signal in a first frequency band. The broadband communication receiving channel for receiving broadband data at the terminal using the first frequency reference signal, wherein a legacy satellite system comprises a legacy communication transmission channel for transmitting data from a legacy satellite in the first frequency band. The second frequency reference generator generates a second frequency reference signal in a second frequency band. The broadband communication transmission channel for transmitting broadband data from the terminal using the second frequency reference signal, wherein the legacy satellite system comprises a legacy communication receiving channel for receiving data at the legacy satellite using the second frequency band.

### CROSS REFERENCE TO OTHER APPLICATIONS

This application claims priority to U.S. Provisional Patent Application No. 63/591,596 entitled METHOD TO AVOID INTERFERENCE BETWEEN GEOSTATIONARY AND LOW EARTH ORBIT SATELLITES SYSTEMS USING COMMON SPECTRUM. filed Oct. 19, 2023 which is incorporated herein by reference for all purposes.

### BACKGROUND OF THE INVENTION

Current low earth orbit (LEO) systems and geosynchronous earth orbit (GEO) systems operate in a co-channel diplex configuration. The frequency for uplink (earth to space communications) is the same for both systems and the frequency for downlink (space to earth communications) is also the same for both systems. This presents a problem in that LEO system transmissions can interfere with GEO system receivers. A significant effort is made to avoid the earth to satellite communications for the LEO systems from interfering with the earth to space communications for the GEO systems. For example, to avoid in-line events (e.g., the LEO satellite is along the same line as the GEO satellite from a terminal), the solution is to dynamically select a different satellite that is not in-line. Similarly, the LEO terminal systems avoid transmitting to a LEO satellite by dynamically avoiding a GEO-arc in order to limit the amount of transmitted power that could be received by the GEO satellite. In addition, a consideration is made for the aggregated effect of multiple earth to satellite transmitters and satellite to earth transmitters which produce this aggregated affect at GEO satellites and ground stations. These efforts need to be determined using a dynamically constrained optimization calculation and compensated for since the locations of the LEO satellites are constantly changing.

### BRIEF DESCRIPTION OF THE DRAWINGS

Various embodiments of the invention are disclosed in the following detailed description and the accompanying drawings.

FIG. 1 is a diagram illustrating an embodiment of a satellite communications system.

FIG. 2 is a diagram illustrating an embodiment of a satellite communication system.

FIG. 3 is a diagram illustrating an embodiment of a satellite communication system.

FIG. 4 is a diagram illustrating an embodiment of a satellite communication system.

FIG. 5 is a diagram illustrating an embodiment of a satellite communication system.

FIG. 6 is a diagram illustrating an embodiment of a satellite network.

FIG. 7 is a diagram illustrating an embodiment of a system for mapping broadband steerable beams to antennas.

FIG. 8 is a diagram illustrating an embodiment of a system for mapping broadband steerable beams to antennas.

FIG. 9 is a diagram illustrating an embodiment of a system for mapping broadband steerable beams to antennas.

FIG. 10 is a diagram illustrating an embodiment of a system using angular division duplexing.

FIG. 11 is a diagram illustrating an embodiment of a system using angular division duplexing.

FIG. 12A is a diagram illustrating an embodiment of a system for antenna nulling.

FIG. 12B is a diagram illustrating an embodiment of a system for antenna nulling.

FIG. 13 is a diagram illustrating an embodiment of a satellite of a satellite system.

FIG. 14 is a diagram illustrating an embodiment of a terminal of a satellite system.

FIG. 15 is a flow diagram illustrating an embodiment of a process for a satellite system.

FIG. 16 is a flow diagram illustrating an embodiment of a process for a satellite system.

FIG. 17 is a flow diagram illustrating an embodiment of a process for a satellite system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The availability of phased arrays, in which the amplitude and phase can be programmed and quickly reprogrammed, allow for new array processing concepts to be applied. These new array processing concepts have their roots in radar systems. Further these new array processing techniques use a single frequency, which does not address the complexities and richness of frequency duplex division communications. The disclosed revises new array processing and other system concepts to diplexed frequency communications to enable coexistence.

The development of higher power, higher frequency transmitters and receivers have allowed the creation of new coexistence techniques that are less useful for arenas previously served using lower frequency systems. As transmission frequencies increase, the associated wavelengths decrease, and thus co-channel signal separation (and thus coexistence and the ability to function at closer geographic proximity) becomes easier using spatial processing and spatial transmission techniques.

Successful coexistences between a high frequency satellite communication system and a second system with the diplex frequencies reversed enable a doubling of the useable spectrum when viewed in the aggregate), and this is the focus of the disclosed system described herein.

In some embodiments, higher millimeter wave frequencies enable narrow pencil-beams that prevent direct transmission from a system's transmitter into a second system's receiver. A null (e.g., a transmission null) can be formed in the direction of a receiver further reducing the interference potential. The direction for the null to be performed is obtain by either: (a) knowledge of the location of the receiver or (b) detection of the transmitting signal. The reversing of the diplex frequencies directly supports this detection. Since a receiver is collocated with a transmitter, the location of the receiver can be inferred by the sensing of the transmission signal (e.g., looking for the transmitted frequency that is known to be collocated with a receiver using a different receive frequency).

In some embodiments, the reversed diplexer communication system can also employ a received beam null in the direction of the legacy system. The null will reduce the impact of the legacy system's transmissions on the reversed diplexer communication system's receiver. This will further reduce the interference potential and enhances coexistence.

In some embodiments, a terminal, a satellite, or a control system such as a software defined network has a stored database of locations of other system terminals and other system satellites and/or an understanding of the carrier frequency used for transmission. This location, frequency information, and/or other data such as topological information can be used to calculate the probability of potential interference of a transmitted signal (e.g., is within a distance that the transmitted signal at its frequency will interfere with a system receiver). A determination can be made as to whether an other system terminal or an other system satellite would generate potential interference to the system's terminal or satellite (e.g., that the other system terminal or satellite transmitter is within a threshold distance of the system receiver or is close enough transmitting the frequency towards the system receiver to cause interference). In response to the other system's device generating potential interference (e.g., being within some distance to cause interference at the frequency), indicating to the antenna to create a null (e.g., a receiving null) to reduce interference between the other system and the system's terminal or satellite. In some embodiments, a terminal or a satellite has a detector for transmissions from other system terminals and other system satellites and an understanding of the carrier frequency used for reception. This detection of an other system and direction that the other system has from the system can be used to calculate potential interference of a received signal from the system. A determination can also be made as to whether an other system terminal or an other system satellite is potentially interfering with the system's terminal or satellite. In response to the other system's device being potentially interfering, indicating to the antenna to create a null (e.g., a receiving null) to reduce interference between the other system and the system's terminal or satellite. In some embodiments, a combination of detection and using a database of stored location information are used in combination to determine whether or not to create a null (e.g., a receiving null) and where or which direction to create a null.

In some embodiments, a terminal, a satellite, or control systems such as a software defined network has a stored database of locations of other system terminals, other system satellites, or other terrestrial systems (e.g., fixed data terminals, mobile base stations, possible mobile endpoint devices, etc.) and an understanding of the carrier frequency these systems use for reception. This location and frequency information and/or other data such as topological information can be used to calculate a probability of potential interference of a received signal from the system. A determination can be made as to whether an other system device (e.g., other system terminal(s), other system satellite(s), etc.) would have a high probability of potential interference from the transmissions of the system's terminal or satellite. In response to the other system's device being subject to potential interference, indicating to the antenna to create a null (e.g., a transmitting null) to reduce interference between the system and the other system's terminal or satellite. In some embodiments, a terminal or a satellite has a detector for transmissions from other system terminals, other system satellites, other terrestrial or airborne systems and/or an understanding of the carrier frequency that those systems use for reception and transmission. This enables detection at the system's receiver of transmissions from an other system (which may be on a different carrier frequency) and direction that the other system has from the system can be used to calculate potential interference of a transmitted signal from the system. A determination can be made as to whether an other system terminal or an other system satellite is potentially interfered with by the system's terminal or satellite transmissions in that detected direction of the other system. In response to the system's device being potentially interfering, indicating to the antenna to create a null (e.g., a transmitting null) to reduce interference to the other system from the system's terminal or satellite. In some embodiments, a combination of detection where other systems are and using a database of stored location information are both used to determine whether or not to create a null (e.g., a transmitting null) and where or which direction to create that null.

In some embodiments, a similar system is used in creating a receiving null using the antenna at a system satellite, system terminal, or airborne system location—a location for another system is detected or looked up in a database, a determination is made as to whether the transmission from that other system is potentially interfering, and in response to determining that transmission from that other system is potentially interfering, indicating to form a receiving null for that detected or looked up other system (e.g., a null in the direction of or for the location of that potentially interfering other system transmitter).

A satellite or aircraft communication system is disclosed. The satellite or aircraft communication system comprises a first frequency reference generator of a satellite or aircraft, a broadband communication receiving channel, a second frequency reference generator of the satellite or aircraft, and a broadband communication transmission channel. The first frequency reference generator generates a first frequency reference signal in a first frequency band. The broadband communication receiving channel is for receiving broadband data at the satellite or aircraft using the first frequency reference signal, wherein a legacy satellite system comprises a legacy communication transmission channel for transmitting data from a legacy satellite in the first frequency band. The second frequency reference generator generates a second frequency reference signal in a second frequency band. The broadband communication transmission channel is for transmitting broadband data from the satellite or aircraft using the second frequency reference signal, wherein the legacy satellite system comprises a legacy communication receiving channel for receiving data at the legacy satellite using the second frequency band.

A satellite communication system is disclosed. The satellite communication system comprises a first frequency reference generator of a terminal, a broadband communication transmission channel, a second frequency reference generator of the terminal, and a broadband communication receiving channel. The first frequency reference generator generates a first frequency reference signal in a first frequency band. The broadband communication transmission channel is for transmitting broadband data from the terminal using the first frequency reference signal, wherein a legacy satellite system comprises a legacy communication receiving channel for receiving data at a legacy terminal in the first frequency band. The second frequency reference generator generates a second frequency reference signal in a second frequency band. The broadband communication receiving channel is for receiving broadband data at the terminal using the second frequency reference signal, wherein the legacy satellite system comprises a legacy communication transmission channel for transmitting data from the legacy terminal using the second frequency band.

Satellite systems typically operate using two sets of frequencies one used by the satellite to transmit to a ground terminal (space to earth), and one used by the ground terminal to communicate with the satellite (earth to space) using Frequency Division Duplexing (FDD). Both user terminals and satellites use directional antennas to focus radio signals to avoid interference and reuse spectrum between multiple systems.

GEO satellites operate in orbits approximately 36,000 km high, and do not move relative to the earth, so terminals point to a fixed spot in the sky. LEO satellites operate in much lower orbits (100-1,000 km), constantly move relative to the earth, and require many more satellites to provide continuous service over a specific area. Normally, when GEO and LEO satellites operate in the same frequency bands, they use the frequencies from earth to space and space to earth communications in the same way. This is using the frequencies in a co-channel manner.

Both GEO and LEO satellites operate in the same spectrum creating a problem as GEO satellites, which were in service earlier, must be protected from interference by the newer LEO systems. When a user terminal is transmitting to a LEO satellite, the signal may continue to propagate on to a GEO satellite, which causes interference to GEO satellite operations. Likewise, strong LEO satellites signals pointed at the ground can also be received by GEO terminals when they enter the area of the sky the terminal's antenna is pointed at, again causing problematic interference.

The current approaches that deal with the interference problems with co-channel operations between GEO and LEO satellites have significant drawbacks. One approach is to have LEO satellites and their user terminals avoid transmitting in the direction of GEO satellites by transmitting at angles that point away from the equator over which the GEO satellites orbit. In this case, the angle from the terminal to the LEO satellite (relative to the ground) will be much lower than when communicating to a LEO satellite more directly overhead. This means a longer distance through more atmosphere, which can degrade performance, especially in rainy weather. Also, at lower angles, terrain, trees, buildings, or other clutter are much more likely to block the signal completely, resulting in periodic outages. User terminals would, with this approach, need a much larger portion of the sky clear of trees or buildings for reliable service. This significantly constrains the locations where the terminals can be placed and would be able to utilize the satellite service without periodic outages. In other words, the aperture of the LEO satellite terminal must be constrained to avoid interference with the GEO; the LEO system terminals point their directional antennas in a way to minimize signal emissions towards the equator, where the GEO satellites orbit and transmit to LEO satellites at higher (or lower in the Southern hemisphere) latitudes.

Another approach is for the terminal to use a beamformed signal and to switch to a satellite that is not colinear with a GEO satellite using a dynamic solver. This approach has challenges both with potential interference from aggregated effects of large numbers of a terminal's sidelobes (typically captured through equivalent power flux density). Additionally, switching traffic to alternate satellites may result in less reliable service for LEO users, particularly if the alternate satellites are closer to the horizon and impaired by trees or buildings.

A satellite or aircraft communication system is disclosed. Reversing the spectrum configuration for the LEO satellite system avoids these drawbacks by completely avoiding the co-channel problem. Using this method, there are no constraints on aperture, and a LEO terminal can communicate with LEO satellites or aircraft directly overhead at all latitudes, or when pointed directly at a GEO satellite with no impact on the GEO satellite operation. This also allows use of the system in hilly or forested areas where only the sky directly above the terminal is clear. Because no in-line co-channel events can occur and there is no reason to avoid pointing towards GEO-arc, there is no reason to use a dynamic solver.

In some embodiments, there are challenges to making the reversing of the channel spectrum. For example, there can be local interference between LEO transmitters on the ground in close radio proximity to GEO receivers on the ground: LEO transmitters may leak energy into the GEO receivers. However, the combination of high frequency, narrow LEO transmission beams, and near-field effects should eliminate interference except in cases of exceptionally close proximity between the LEO transmitter and a GEO receiving terminal.

Additionally, average distances from the LEO terminal to a LEO satellite will be smaller, resulting in less attenuation from rain or other weather, increased performance, and reliability. The system is also much simpler with less switching, less aggressive interference mitigation needed, and delivering much more robust interference protection to GEO satellite customers, especially those customers operating in higher latitudes where signals are weaker or those customers using much smaller terminals that send weaker signals to the GEO satellite receivers. Because of these weaker signals, these customers are more suspectable to interference from aggregated LEO user terminal transmissions.

LEO ground terminals transmit (earth to space) on the frequency that GEO satellites transmit (space to earth) to their user terminals. Because GEO satellites do not receive on this frequency, no interference occurs. LEO satellites would transmit (space to earth) on the same frequency a GEO user terminal would transmit (earth to space). This avoids interference from the LEO satellite because the GEO user terminal does not receive on the frequency the terminal transmits.

The disclosed differs from techniques currently used to allow common use of radio frequency spectrum between GEO and LEO satellites.

The system is also much simpler with less switching and less aggressive beamforming needed and delivering much more robust interference protection to GEO satellite customers, especially those operating in higher latitudes where signals are weaker or customers using much smaller terminals that are more sensitive to interference.

In some embodiments, this method can be applied to other configurations satellite, aircraft, or terrestrial communication systems that can operate in the same spectrum but are spatially separated. For example, this could be airborne systems (e.g., with one part of the system in an aircraft, a balloon, a blimp, etc.) or other satellite configurations such as geostationary systems spectrum being reused by medium earth orbit (MEO) systems with greater aperture flexibility than in use today. In the examples disclosed herein, the system is frequently described as including a ground based terminal and a LEO satellite, however it is apparent to someone practiced in the art that the system could include a transmitter/receiver located on an aircraft (e.g., an airplane, a helicopter, a balloon, a blimp, a dirigible, etc.) instead of or in addition to a LEO satellite based transmitter/receiver.

In some embodiments, another method to reduce the possibility of interference to an other system, whether that other system includes a terminal, a satellite, a terrestrial infrastructure, such as fixed terrestrial links or cellular mobile networks with a fixed base station and mobile endpoints, or even facilities like radio astronomy observatories, would be to incorporate data (e.g., upon request, or periodically, according to a predetermined schedule, etc.) from a database containing information such as location, frequency of operation, topological information, and other data that can be used to calculate possible interference between the system's terminal, the system's satellite, or the system's aircraft and the other system listed in that database. This database could be a database from a regulator (e.g., the Federal Communications Commission), a database that is collected from a spectrum survey from space, collected terrestrially, or a database generated through the analysis of satellite imagery to determine the location of antenna structures of various types. When a terminal from the system requests to join the network and transmits its location to the system's satellite or aircraft (e.g., provides the network with a terminal location), the satellite, aircraft, or a control system (e.g., a software defined network) can perform a calculation to determine the possibility of the system's terminal to create potential interference to an other system (e.g., determines whether there is an interference possibility to an other system, wherein the other systems and the other system information is stored in a database) and, in various embodiments, in response to determining that there is the interference possibility to the other systems perform one or more of the following: 1) instruct the terminal to use frequencies that would lessen the potential for interference (e.g., the terminal would transmit on the frequencies to reduce interference—avoiding similar frequencies of the other system(s) or going to higher frequencies so that the signal at the other system(s) is reduced given the distance to the other system), 2) generate a null in the direction of the other system that would lessen the probability of interference, or 3) deny service to that terminal to prevent causing interference to the other system, or any other appropriate measure or combination thereof. The system may also transmit information to the system's terminal such that it or another device used by an installer or other personnel can display the reason service was denied and any actions that could be taken to change the location of the terminal so it would not cause interference. This calculation may also be done when the system's terminal is ordered by a customer to prevent it being shipped to a location that may generate such interference when made operational. In some embodiments, the strategies can be triggered or run periodically in the case where there are changes to the number and existence of other systems that the system might interfere with (e.g., mobile system moving in to range of being interfered with, a new other system being installed and indicated in a database, etc.).

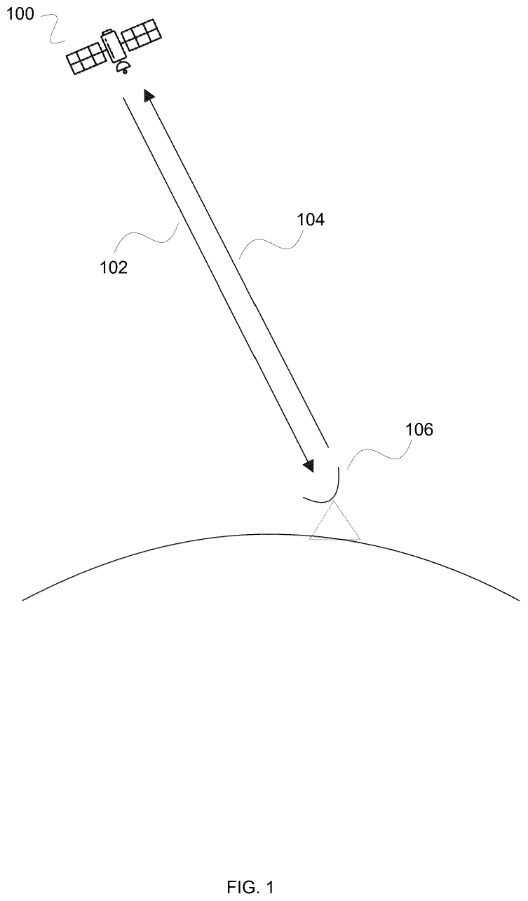

FIG. 1 is a diagram illustrating an embodiment of a satellite communications system. In the example shown, legacy satellite system 100 (e.g., a geostationary satellite system) communicates with terminal 106 on a space to earth frequency 102 (F1) and an earth to space frequency 104 (F2). Legacy satellite system 100 comprises a communication receiving channel using a first frequency, wherein a legacy satellite system comprises a legacy communication transmission channel using the first frequency and a communication transmission channel using a second frequency, wherein the legacy satellite system comprises a legacy communication receiving channel using the second frequency.

In some embodiments, the legacy satellite system uses the frequency band 27-30 GHz for earth to satellite communications.

In some embodiments, the legacy satellite system uses the frequency band 40-42 GHz for earth to satellite communications.

In some embodiments, the legacy satellite system uses the frequency band 47-52 GHz for earth to satellite communications.

In some embodiments, the legacy satellite system uses the frequency band 17-20 GHz for satellite to earth communications.

In some embodiments, the legacy satellite system uses the frequency band 20-24 GHz for satellite to earth communications.

In some embodiments, the legacy satellite system uses the frequency band 37.5-42.5 GHz for satellite to earth communications.

In some embodiments, earth to satellite frequency band comprises 17-20 GHz and satellite to earth frequency band comprises 27-30 GHz.

In some embodiments, earth to satellite frequency band comprises 20-24 GHz and satellite to earth frequency band comprises 40-42 GHz.

In some embodiments, earth to satellite frequency band comprises 37.5-42.5 GHz and t satellite to earth frequency band comprises 47-52 GHz.

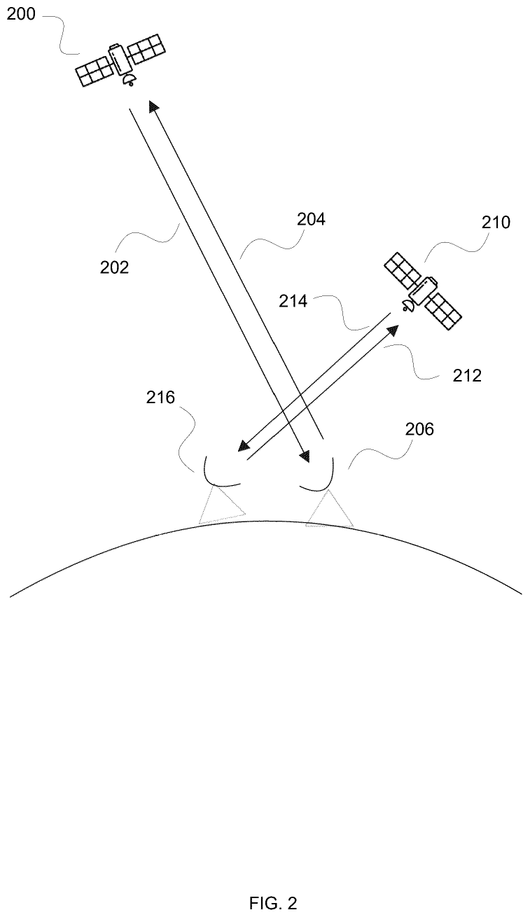

FIG. 2 is a diagram illustrating an embodiment of a satellite communication system. In the example shown, satellite system 200 (e.g., a geostationary earth orbit (GEO) satellite system) communicates with a terminal 206 on a space to earth frequency 202 (F1) and an earth to space frequency 204 (F2). Satellite system 210 (e.g., a low earth orbit (LEO) satellite system) uses a reverse of the earth to space frequency 212 (F1) and space to earth frequency 214 (F2) selection compared to satellite system 200 (e.g., the GEO satellite system). Satellite system 210 (e.g., a LEO satellite system) communicates with Terminal 216 on a space to earth frequency 214 (F2) and earth to space frequency 212 (F1). The system uses the spectrum in a normal and reverse diplex configuration (e.g., reversing the space-to-earth and the earth-to-space directions relative to the legacy system) while co-existing and not interfering with the legacy system.

In other words, satellite system 200 (e.g., the GEO satellite system) is transmitting to the earth using space to earth frequency 202 (F1) and is receiving radio signals from terminal 206 (e.g., a customer user terminal) on earth to space frequency 204 (F2). Terminal 206 (e.g., a GEO user terminal) receives signals from satellite system 200 on space to earth frequency 202 (F1) and transmits to satellite system 200 on earth to space frequency 204 (F2).

While several LEO satellites (e.g., like satellite system 210) are likely in the view of terminal 216, consider one satellite (e.g., satellite system 210) with terminal 216 assigned to communicate with at a specific time. Satellite system 210 (e.g., a LEO satellite) transmits a signal using a directional antenna pointed at terminal 216 using space to earth frequency 214 (F2). Terminal 216 (e.g., the LEO user terminal) transmits up to satellite system 210 (e.g., the LEO satellite) on earth to space frequency 212 (F1), the frequency (e.g., space to earth frequency 202) used by satellite system 200 (e.g., the legacy geo satellite) to transmit to the earth on. Satellite system 210 has a directional antenna that receives frequency F1 (e.g., earth to space frequency 212) only from the earth, and not from above the satellite.

Satellite system 200 (e.g., the GEO satellite system) is transmitting to the earth using frequency F1 (e.g., space to earth frequency 202) and is listening for communications from terminal 206 (e.g., a customer user terminal) on frequency F2 (e.g., earth to space frequency 204). Because satellite system 200 is transmitting on F1, satellite system 200 cannot effectively receive a signal on frequency F1. Radio signals sent in the direction of satellite system 200 will not interfere with signals received at frequency F2. Terminal 206 (e.g., the GEO user terminal) receives signals from satellite system 200 (e.g., the GEO satellite system) on frequency F1 and transmits to satellite system 200 on frequency F2. Because terminal 206 transmits on frequency F2, terminal 206 cannot effectively receive a signal on frequency F2.

Interference with the legacy satellite systems (e.g., the GEO satellites systems) is avoided by having the newer satellite systems (e.g., the LEO satellite systems) reverse the space to earth and earth to space frequencies being used by the legacy satellite system (e.g., the GEO satellite systems) and avoid the interference that can occur when both the legacy and newer satellite systems (e.g., the LEO and GEO satellite systems) operate in the same diplexing configuration.

In some embodiments, satellite system 210 (e.g., the newer LEO satellite system) transmits a highly directional signal to terminal 216 using space to earth frequency 214 (F2). Because this signal is pointed down to the earth and not above where satellite system 200 (e.g., the legacy GEO satellite system) orbits, no radio signal at frequency F2 is emitted in the direction of satellite system 200. Likewise terminal 206 does not receive on frequency F2 because it is transmitting on frequency F2, and no interference to terminal 206 occurs.

In some embodiments, terminal 216 (e.g., the newer LEO user terminal) transmits up to satellite system 210 (e.g., the newer LEO satellite system) on frequency F1, and although this signal may well propagate up to higher orbits where satellite system 200 is located, satellite system 200 is not receiving on frequency F1, and therefore terminal 216 (e.g., the newer LEO user terminal) does not interfere with satellite system 200.

This spectrum configuration for LEO and GEO satellite systems allows the frequencies F1 and F2 to be used by both satellite systems without mutual interference.

In some embodiments, a LEO satellite system must receive regulatory authorization to operate. If the LEO operator wishes to reuse the same spectrum being used by a GEO satellite system, the LEO system design would need to reverse the frequencies used for earth to space and space to earth operation.

In some embodiments, the reversed frequency operation (reversed diplexing) would need to be submitted as part of the request for regulatory approval and be designed into the satellite's communications systems.

In some embodiments, the above elements are necessary if both the geostationary and low earth orbit systems are both bidirectional communications systems. If one system is unidirectional (broadcast only), fewer elements may be needed.

In some embodiments, terminal 206 and terminal 216 would not normally interfere with each other if this diplexing approach is used. However, if terminal 206 and terminal 216 are located very close together and near metal or other material that reflects radio signals, then the reflected energy from one of the terminals transmissions could be received by the other terminal. An example of this might be two terminals located very close to each other on a ship's deck, with masts nearby that could reflect some of the transmitted radio signals back into the antenna of the other terminal.

One way of improving the system operation in this case (beyond introducing additional separation distance between the terminals or prohibiting the use of LEO terminals in close proximity to GEO terminals) would be to coordinate frequency use between the systems so that the exact same frequencies would not be used by both terminals. For example, instead of transmitting on frequency F1, terminal 216 could operate higher or lower in the same band of frequencies for earth to space communications to satellite system 210, perhaps 100 to 200 MHz away. This could result in fewer frequencies being used by terminal 216 in the earth to space direction resulting in lower performance but may be an acceptable alternative to prohibiting nearby operation.

Any LEO system operator or designer seeking spectrum to operate could utilize the disclosed to reuse the same spectrum in use by a geostationary satellite system, without aperture restrictions.

Spectrum is a finite resource and by using the disclosed, the same GEO satellite system spectrum can be reused for new LEO systems.

In some embodiments, the disclosed is useful in other scenarios where there is similar spatial separation between systems where Frequency Division Duplexing (FDD) is being used.

In some embodiments, in the case where directional antennas can keep radio frequency energy being radiated above or below a communications node, such as at different altitudes, the disclosed is useful in resolving interference between satellite and non-satellite systems, or even where both systems are non-satellite systems.

Also, the disclosed can be used in other configurations of satellite or other communication systems that can operate in the same spectrum but are spatially separated. This could be airborne systems (e.g., an airplane, an aircraft, a balloon, a blimp, etc.), or other satellite configurations such as geostationary systems spectrum being reused by medium earth orbit (MEO) systems with greater aperture flexibility than in use today.

In some embodiments, the interference between the system and the legacy system is avoided by exploiting properties of antennas. A high level of spatial diversity is achieved by use of large antennas, which are able to produce pencil beams that can be precisely scheduled, controlled, and used with or without co-ordination in both transmitting and receiving directions without interference to legacy systems. In addition, with the reversed system frequencies, the system can communicate in both space to earth and earth to space directions with much smaller scan angles relative to broadside communications and in no instance crossing 45 degrees of scan in either direction. This profile for signal scanning avoids clutter and occlusion problems.

In some embodiments, the earth to satellite communication frequency and the satellite to earth communication frequency are 20 GHz and above (e.g., Ka band or higher).

In some embodiments, the earth to satellite communication frequency and the satellite to earth communication frequency are 10 GHz and above (e.g., Ku band or higher).

In some embodiments, the satellite to earth spectrum comprises 27-30 GHz, 40-42 GHz, and 47-52 GHz for data signals, whereas the legacy GEO system uses 17-20 GHz, 20-24 GHz, and 37.5-42.5 GHz spectrum, respectively, for satellite to earth transmissions. In some embodiments, the earth to satellite spectrum comprises 17-20 GHz, 20-24 GHz, and 37.5-42.5 GHz for data signals, whereas the legacy GEO system uses 27-30 GHz, 40-42 GHz, and 47-52 GHz spectrum, respectively, for satellite to earth transmissions.

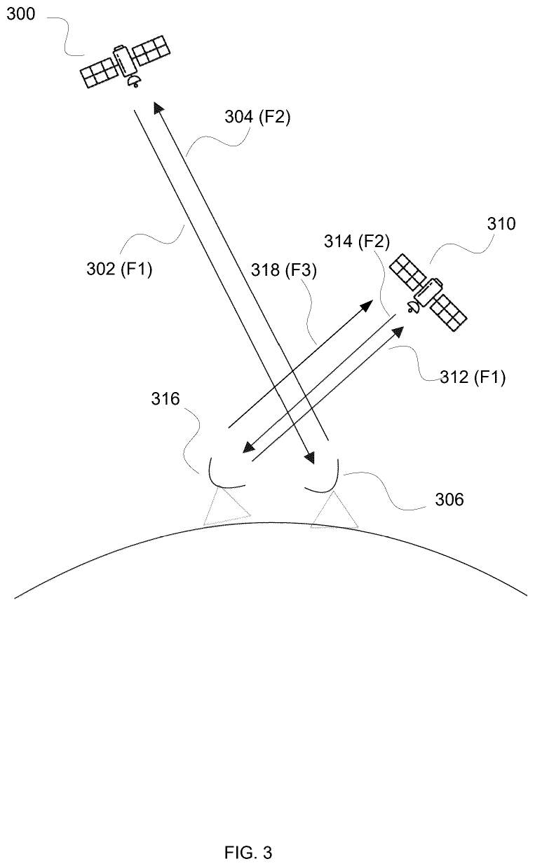

FIG. 3 is a diagram illustrating an embodiment of a satellite communication system. In the example shown, satellite system 300 (e.g., a GEO satellite system) communicates with a terminal 306 on a space to earth frequency 302 and an earth to space frequency 304. Satellite system 310 (e.g., a LEO satellite system) uses a reverse of the earth to space and space to earth frequency selection compared to satellite system 300 (e.g., the GEO satellite system). Satellite system 310 (e.g., a LEO satellite system) communicates with Terminal 316 on an earth to space frequency 312 of F2 and space to earth frequency 314 of F1. In addition, satellite system 310 (e.g., the LEO satellite system) receives communication signal(s) from Terminal 316 using frequency 318 either F1 or F3. In some embodiments, F3 is not in the same band as either F1 or F2. In some embodiments, F3 is in the same band as F1 but angular techniques are used to avoid sending signals toward a GEO satellite.

In the example shown, satellite system 300 (e.g., a geostationary earth orbit (GEO) satellite system) communicates with a terminal 306 on a space to earth frequency 302 (F1) and an earth to space frequency 304 (F2). Satellite system 310 (e.g., a low earth orbit (LEO) satellite system) uses a reverse of the earth to space frequency 312 (F1) and space to earth frequency 314 (F2) selection compared to satellite system 300 (e.g., the GEO satellite system, where the legacy system uses frequency 302 (F1) in the space to earth direction and frequency 304 (F2) in the earth to space direction). Satellite system 310 (e.g., a LEO satellite system) communicates with Terminal 316 on a space to earth frequency 314 (F2) and earth to space frequency 312 (F1).

In other words, satellite system 300 (e.g., the GEO satellite system) is transmitting to the earth using space to earth frequency 302 (F1) and is receiving radio signals from terminal 306 (e.g., a customer user terminal) on earth to space frequency 304 (F2). Terminal 306 (e.g., a GEO user terminal) receives signals from satellite system 300 on space to earth frequency 302 (F1) and transmits to satellite system 300 on earth to space frequency 304 (F2).

While several LEO satellites (e.g., like satellite system 310) are likely in the view of terminal 316, consider one satellite (e.g., satellite system 310) with terminal 316 assigned to communicate with at a specific time. Satellite system 310 (e.g., a LEO satellite) transmits a signal using a directional antenna pointed at terminal 316 using space to earth frequency 314 (F2). Terminal 316 (e.g., the LEO user terminal) transmits up to satellite system 310 (e.g., the LEO satellite) on earth to space frequency 312 (F1), the frequency (e.g., space to earth frequency 302) used by satellite system 300 (e.g., the legacy GEO satellite) to transmit to the earth on. Satellite system 310 has a directional antenna that receives frequency F1 (e.g., earth to space frequency 312) only from the earth, and not from above the satellite.

Satellite system 300 (e.g., the GEO satellite system) is transmitting to the earth using frequency F1 (e.g., space to earth frequency 302) and is listening for communications from terminal 306 (e.g., a customer user terminal) on frequency F2 (e.g., earth to space frequency 304). Because satellite system 300 is transmitting on F1, satellite system 300 cannot effectively receive a signal on frequency F1. Radio signals sent in the direction of satellite system 300 will not interfere with signals received at frequency F2. Terminal 306 (e.g., the GEO user terminal) receives signals from satellite system 300 (e.g., the GEO satellite system) on frequency F1 and transmits to satellite system 300 on frequency F2. Because terminal 306 transmits on frequency F2, terminal 306 cannot effectively receive a signal on frequency F2.

Interference with the legacy satellite systems (e.g., the GEO satellites systems) is avoided by having the newer satellite systems (e.g., the LEO satellite systems) reverse the space to earth and earth to space frequencies being used by the legacy satellite system (e.g., the GEO satellite systems) and avoid the interference that can occur when both the legacy and newer satellite systems (e.g., the LEO and GEO satellite systems) operate in the same diplexing configuration.

In some embodiments, satellite system 310 (e.g., the newer LEO satellite system) transmits a highly directional signal to terminal 316 using space to earth frequency 314 (F2). Because this signal is pointed down to the earth and not above where satellite system 300 (e.g., the legacy GEO satellite system) orbits, no radio signal at frequency F2 is emitted in the direction of satellite system 300. Likewise terminal 306 does not receive on frequency F2 because it is transmitting on frequency F2, and no interference to terminal 306 occurs.

In some embodiments, terminal 316 (e.g., the newer LEO user terminal) transmits up to satellite system 310 (e.g., the newer LEO satellite system) on frequency F1, and although this signal may well propagate up to higher orbits where satellite system 300 is located, satellite system 300 is not receiving on frequency F1, and therefore terminal 316 (e.g., the newer LEO user terminal) does not interfere with satellite system 300.

This spectrum configuration for LEO and GEO satellite systems allows the frequencies F1 and F2 to be used by both satellite systems without mutual interference.

In some embodiments, a LEO satellite system must receive regulatory authorization to operate. If the LEO operator wishes to reuse the same spectrum being used by a GEO satellite system, the LEO system design would need to reverse the frequencies used for earth to space and space to earth operation.

In some embodiments, the reversed frequency operation (reversed diplexing) would need to be submitted as part of the request for regulatory approval and be designed into the satellite's communications systems.

In some embodiments, the above elements are necessary if both the geostationary and low earth orbit systems are both bidirectional communications systems. If one system is unidirectional (broadcast only), fewer elements may be needed.

In some embodiments, terminal 306 and terminal 316 would not normally interfere with each other if this diplexing approach is used. However, if terminal 306 and terminal 316 are located very close together and near lots of metal that reflects radio signals, then the reflected energy from one of the terminals transmissions could be received by the other terminal. An example of this might be two terminals located very close to each other on a ship's deck, with masts nearby that could reflect some of the transmitted radio signals back into the antenna of the other terminal.

One way of improving the system operation in this case (beyond introducing additional separation distance between the terminals or prohibiting the use of LEO terminals in close proximity to GEO terminals) would be to coordinate frequency use between the systems so that the exact same frequencies would not be used by both terminals. For example, instead of transmitting on frequency F1, terminal 316 could operate higher or lower in the same band of frequencies for earth to space communications to satellite system 310, perhaps 100 to 300 MHz away. This could result in fewer frequencies being used by terminal 316 in the earth to space direction resulting in lower performance but may be an acceptable alternative to prohibiting nearby operation.

Any low earth orbit (LEO) system operator or designer seeking spectrum to operate could utilize the disclosed to reuse the same spectrum in use by a geostationary satellite system, without aperture restrictions.

Spectrum is a finite resource and by using the disclosed, the same GEO satellite system spectrum can be reused for new LEO systems.

In some embodiments, the disclosed is useful in other scenarios where there is similar spatial separation between systems where bidirectional Frequency Division Duplexing (FDD) is being used.

In some embodiments, in the case where directional antennas can keep radio frequency energy being radiated above or below a communications node, such as at different altitudes, the disclosed is useful in resolving interference between satellite and non-satellite systems, or even where both systems are non-satellite systems.

Also, the disclosed can be used in other configurations of satellite or other communication systems that can operate in the same spectrum but are spatially separated. This could be airborne systems (e.g., an airplane, an aircraft, a balloon, a blimp, etc.), or other satellite configurations such as geostationary systems spectrum being reused by medium earth orbit (MEO) systems with greater aperture flexibility than in use today.

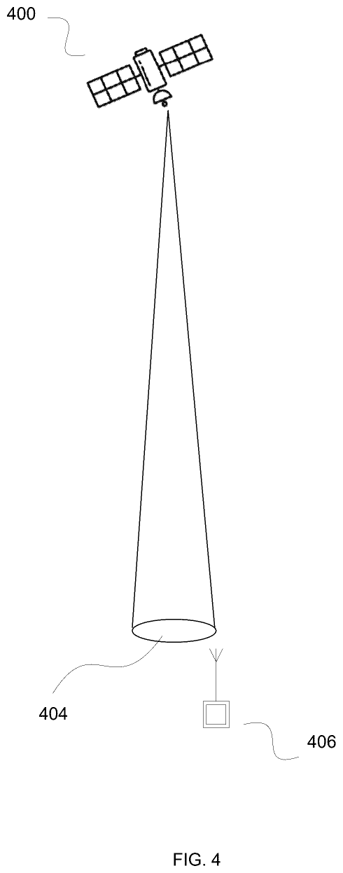

FIG. 4 is a diagram illustrating an embodiment of a satellite communication system. In the example shown, satellite system 400 (e.g., a LEO satellite) communicates with Terminal 406 in two manners: primary data down link 404 using common spectrum around frequency F2.

In some embodiments, primary data down link 404 comprises a high bandwidth data channel with a narrow spot on the ground.

In various embodiments, primary data down link 404 uses a high data rate “pencil beam” signal formed using a beamformed antenna, a phased-array antenna, a metamaterial antenna, reflector antenna, or an RF lens, or combination thereof, or any other appropriate antenna. In some embodiments, pencil beam signals are steered through electrical or electromechanical control of the antenna. In various embodiments, the RX or TX antenna creating the pencil beam comprises an antenna capable of forming a central beam with a half width of less than N degrees, where N is 5 degrees, 4 degrees, 3 degrees, 2 degrees, 1 degree, 6 degrees, 7 degrees, 8 degrees, 9 degrees, 10 degrees, 11 degrees, 12 degrees, 13, degrees, 14 degrees, 15 degrees, 20 degrees, 25 degrees, or any other appropriate number of degrees or fraction thereof.

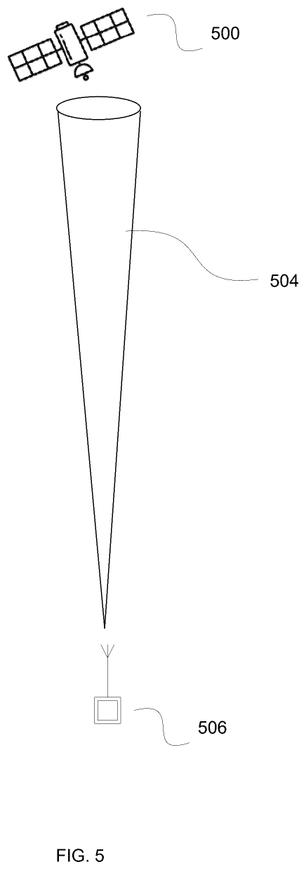

FIG. 5 is a diagram illustrating an embodiment of a satellite communication system. In the example shown, Terminal 506 communicates with satellite system 500 (e.g., a LEO satellite) in two manners primary data up link 504 common spectrum around frequency F1. In some embodiments, the user terminal (e.g., Terminal 506) uses an antenna that points up towards nadir with a directional pattern offset a few tens of degrees offset from nadir that can see 4-6 of the LEO spacecraft above. In various embodiments, the antenna comprises a dedicated aperture, a phased array antenna used for broadband communication that has its beam spoiled to reduce its gain and be able to increase its aperture so it can receive signals from all the spacecraft of interest, or any other appropriate antenna.

In some embodiments, the primary channels operate with limited apertures pointing up towards the sky, further reducing the possible interference from the secondary channel's spread signal.

In various embodiments, primary data up link 504 uses a high data rate “pencil beam” signal formed using a beamformed antenna, a phased-array antenna, a metamaterial antenna, reflector antenna, or an RF lens, or combination thereof, or any other appropriate antenna. In some embodiments, pencil beam signals are steered through electrical or electromechanical control of the antenna. In various embodiments, the RX or TX antenna creating the pencil beam comprises an antenna capable of forming a central beam with a half width of less than N degrees, where N is 5 degrees, 4 degrees, 3 degrees, 2 degrees, 1 degree, 6 degrees, 7 degrees, 8 degrees, 9 degrees, 10 degrees, 11 degrees, 12 degrees, 13, degrees, 14 degrees, 15 degrees, 20 degrees, 25 degrees, or any other appropriate number of degrees or fraction thereof.

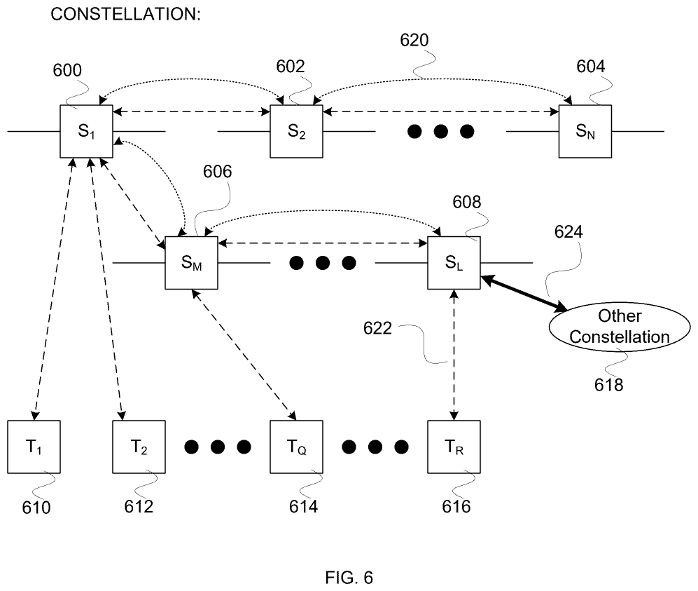

FIG. 6 is a diagram illustrating an embodiment of a satellite network. In some embodiments, the satellites of FIG. 6 (e.g., satellite (S₁) 600, satellite (S₂) 602, satellite (S_{N}) 604, satellite (S_{M}) 606, satellite (S_{L}) 608, etc.) are used for satellite 210, 310, 400, and 500 of satellite system of FIGS. 2, 3, 4, and 5, respectively. In the example shown, the satellite network comprises satellite (S₁) 600, satellite (S₂) 602, satellite (S_{N}) 604, satellite (S_{M}) 606, satellite (S_{L}) 608 and terminal (T₁) 610, terminal (T₂) 612, terminal (T_{Q}) 614, and terminal (T_{R}) 616. Satellite (S₁) 600, satellite (S₂) 602, and satellite (S_{N}) 604, are in one plane/in one shell and satellite (S_{M}) 606 and satellite (S_{L}) 608 are in another plane/other shell. There is a connection (e.g., connection 624) to other constellation 618 from the satellite network. Data connection 622 is shown between terminal (T_{R}) 616 and satellite (S_{L}) 608, and there are other data connections shown between satellite (S_{M}) 606 and satellite (S_{L}) 608, between satellite (S_{M}) 606 and satellite (S₁) 600, between satellite (S₁) 600 and satellite (S₂) 602, between satellite (S₂) 602 and satellite (S_{N}) 604, between satellite (S_{M}) 606 and terminal (T_{Q}) 614, between terminal (T₂) 612 and satellite (S₁) 600, and between terminal (T₁) 610 and satellite (S₁) 600. There are timing synch connections shown between satellite (S₁) 600 and satellite (S₂) 602, satellite (S₂) 602 and satellite (S_{N}) 604 (e.g., link 620), satellite (S₁) 600 and satellite (S_{M}) 606, and satellite (S_{M}) 606 and satellite (S_{L}) 608.

In some embodiments, the satellite network of FIG. 6 comprises aircraft nodes in addition to or instead of LEO satellites.

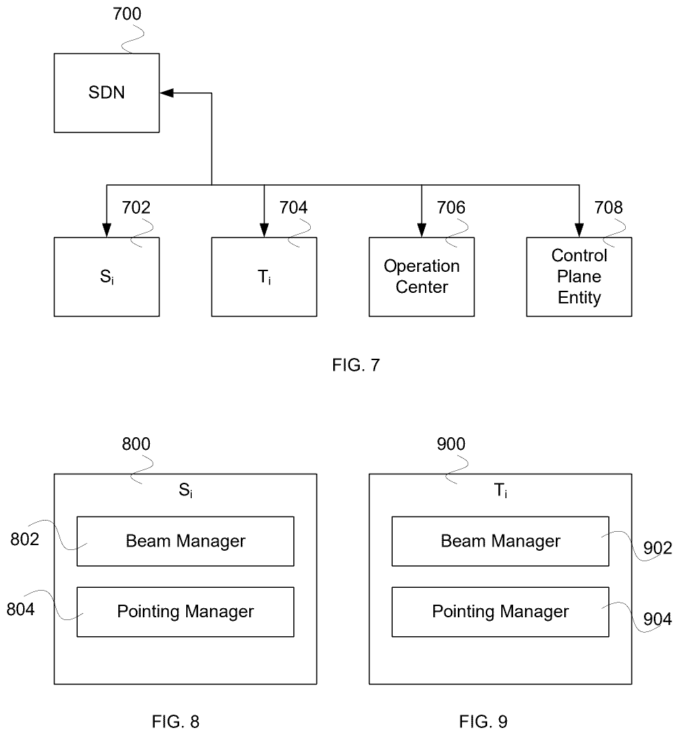

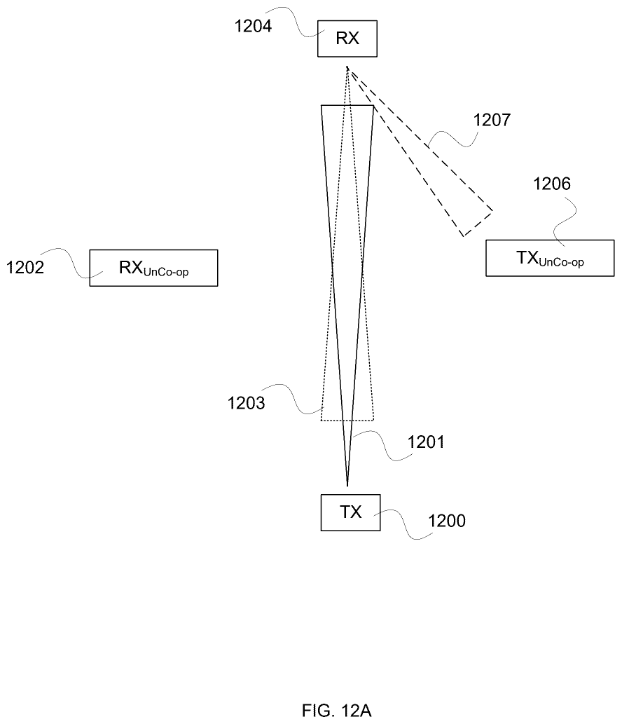

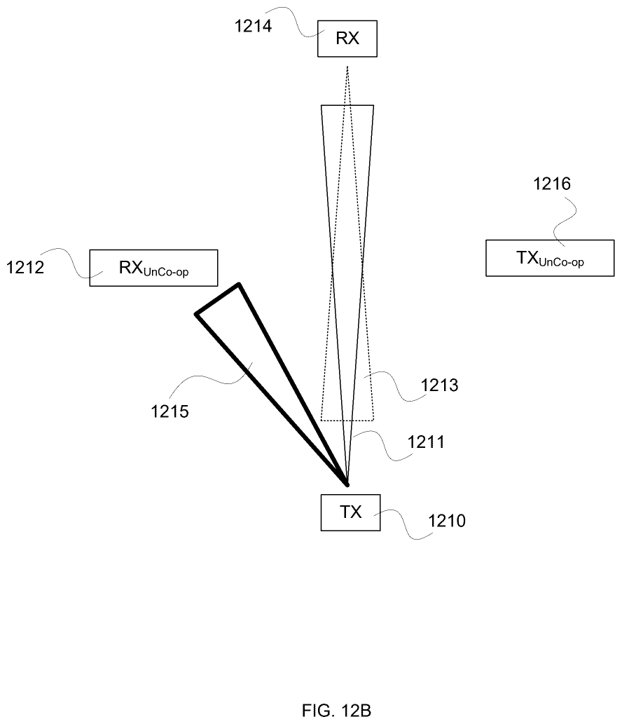

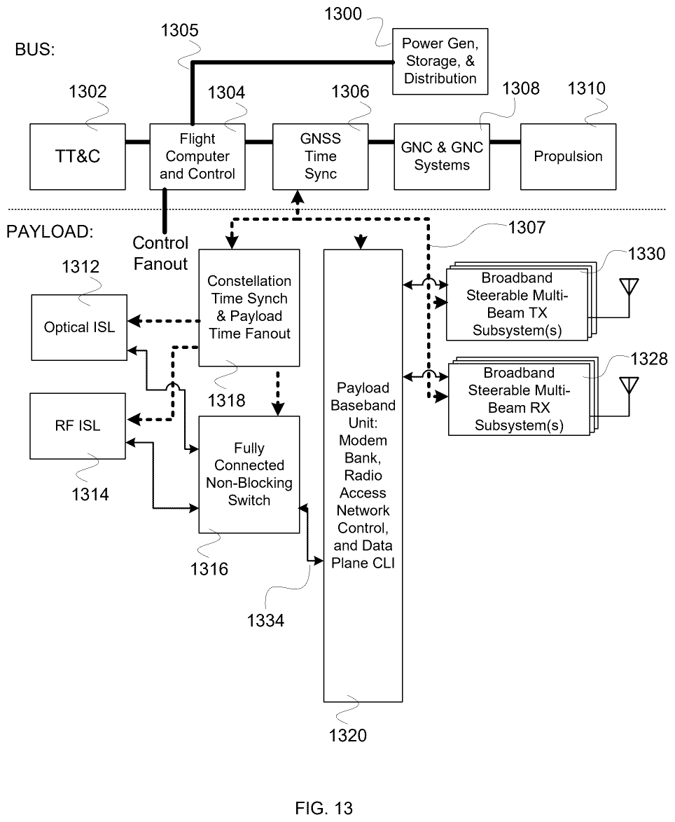

FIG. 7 is a diagram illustrating an embodiment of a system for mapping broadband steerable beams to antennas. In some embodiments, the broadband steerable beams comprise broadband steerable beams associated with broadband steerable TX subsystem(s) or RX subsystem(s) of FIG. 12 or FIG. 13A. In the example shown, at the system level, first software defined networking (SDN) 700 plans which satellite serves which area and which users and from which start time to which end time. The next level details are then planned by SDN 700 including which frequency and channel to use for which TX or RX, how much bandwidth, how to make sure interference and weather are accounted for (e.g., to calculate needed TX power and so on; on both a per-beam basis and per-satellite or per-terminal basis). SDN 700 then fans out (e.g., distributes) these schedules to all network nodes well before the start times. In various embodiments, network nodes comprise one or more of a satellite (e.g., Sᵢ 702), a ground terminal (e.g., Tᵢ 704), a control plane entity (e.g., control plane entity 708), an operation center (e.g., operation center 706), or any other appropriate network node.

FIG. 8 is a diagram illustrating an embodiment of a system for mapping broadband steerable beams to antennas. In some embodiments, the satellite of FIG. 8 is used to implement satellite (e.g., Sᵢ 702) of FIG. 7. In the example shown, the satellite (e.g., Sᵢ 800) includes beam manager 802 and pointing manager 804. On the satellite TX or RX, a schedule is ingested by beam manager 802, which basically knows where it will be at the start time, which area it needs to point to (e.g., where the area is specified in earth centered, earth fixed (ECEF) or other co-ordinates) and computes them into angles from the satellite (e.g., theta, phi relative to the satellite nadir pointing). Beam manager 802 then does the next level of work to figure out the antenna driver parameters, which, depending on the antenna structure, could be element level phases, etc. These antenna driver parameters are then updated by pointing manager 804 at a specific update rate—so that, as the satellite moves, the beam continues to point to the right point on the ground (e.g., a beam is directed to a location roughly every tens of milliseconds). Then either for beam sharing reasons or at the end time, there can be big jumps coming from the pointing manager 804. In some embodiments, if the jumps are for beam sharing, the jumps are for cycling between one of N spots on some schedule (e.g., on one location (a first spot) for a time (a first duration) and then on another location (a second spot) for another time (a second duration), etc.). At handover, as the users associated with a spot are handed over (e.g., as in traffic to that spot is no longer routed through that beam) and that TX or RX beam either gets assigned to serve a new spot or stays unassigned for a defined set of time (all of which is known through the schedule). In some embodiments, RX beams are independently controlled with respect to TX beams (e.g., there is no tight timing relationship between TX and RX).

FIG. 9 is a diagram illustrating an embodiment of a system for mapping broadband steerable beams to antennas. In some embodiments, the terminal of FIG. 9 is used to implement terminal (e.g., Tᵢ 704) of FIG. 7. In the example shown, the terminal (e.g., Tᵢ 900) includes beam manager 902 and pointing manager 904. On the satellite TX or RX, a schedule is ingested by beam manager 902, which basically knows where it will be at the start time, which area it needs to point to (e.g., where the area is specified in earth centered, earth fixed (ECEF) or other co-ordinates) and computes them into angles from the satellite (e.g., theta, phi relative to the satellite nadir pointing). Beam manager 902 then does the next level of work to figure out the antenna driver parameters, which, depending on the antenna structure, could be element level phases, etc. These antenna driver parameters are then updated by pointing manager 904 at a specific update rate—so that, as the satellite moves, the beam continues to point to the right point on the ground (e.g., a beam is directed to a location roughly every tens of milliseconds). Then either for beam sharing reasons or at the end time, there can be big jumps coming from the pointing manager 904. In some embodiments, if the jumps are for beam sharing, the jumps are for cycling between one of N spots on some schedule (e.g., on one location (a first spot) for a time (a first duration) and then on another location (a second spot) for another time (a second duration), etc.). At handover, as the users associated with a spot are handed over (e.g., as in traffic to that spot is no longer routed through that beam) and that TX or RX beam either gets assigned to serve a new spot or stays unassigned for a defined set of time (all of which is known through the schedule). In some embodiments, RX beams are independently controlled with respect to TX beams (e.g., there is no tight timing relationship between TX and RX).

In some embodiments, the RX and TX antennas for terminals and satellites of the system comprises one or more of the following: a beamformed antenna, a metamaterial antenna, a radiofrequency (RF) lens, or combinations thereof, or any other appropriate antenna. In some embodiments, the pencil beam or narrow beam requirements for the system establish the antenna selection (e.g., directivity, gain, beamwidth, efficiency, etc.) with frequency characteristics and aperture size as important parameters. In various embodiments, the RX or TX antenna comprises an antenna capable of forming a central beam with a half width of less than N degrees, where N is 5 degrees, 4 degrees, 3 degrees, 2 degrees, 1 degree, 6 degrees, 7 degrees, 8 degrees, 9 degrees, 10 degrees, 11 degrees, 12 degrees, 13, degrees, 14 degrees, 15 degrees, 20 degrees, 25 degrees, or any other appropriate number of degrees or fraction thereof.

In some embodiments, the satellite and the terminal in order to form and point the beams using the antenna, in addition to frequency, aperture, and efficiency, both ends need to know their relative orientation so that the angle (e.g., theta and phi) for pointing the antennas is known.

In some embodiments, the antenna of a satellite system or a terminal system has the following characteristics:
a. The right frequency tuning (resonant frequencies; down to dipole sizes; standing wave compute etc.);
b. The right efficiency (antenna matching etc.);
c. The right physical aperture and effective area; and
d. Sense of relative orientation to a very fine-grained precision (0.1 degrees).

In some embodiments, the operations of the system (e.g., a transmitter and a receiver) and the operations of a non-cooperative system (e.g., non-cooperative transmitter and a non-cooperative receiver) are at a same frequency. The use of high gain and large number of element array apertures enable coexistence with a non-cooperative communication system operating with the reverse diplex configuration. Coexistence is enabled by: 1) maximizing the Signal to Noise pulse Interference Ratio (SINR) for the receiver while reducing the Interference signal at the non-cooperative receiver—that is, reducing the impact of the non-cooperative transmitters energy on the receiver; and 2) minimizing the signal from any transmitter to the non-cooperative receiver.

In some embodiments, multiple techniques that can be used individually or in combination for this coexistence are enabled by the overall method of angle division duplexing (ADD). For coexistence between non-cooperative transmitters/receivers using angular separation, two relevant cases exist: 1) transmitter with narrow beams, non-cooperative receiver with wide beams and 2) transmitter with narrow beams and non-cooperative receiver with narrow beams. As with frequency division duplexing (FDD) and time division duplexing (TDD) systems, the finer resolution of FDD or TDD, the greater the flexibility and isolation of the systems. This greater flexibility produces a greater system capacity.

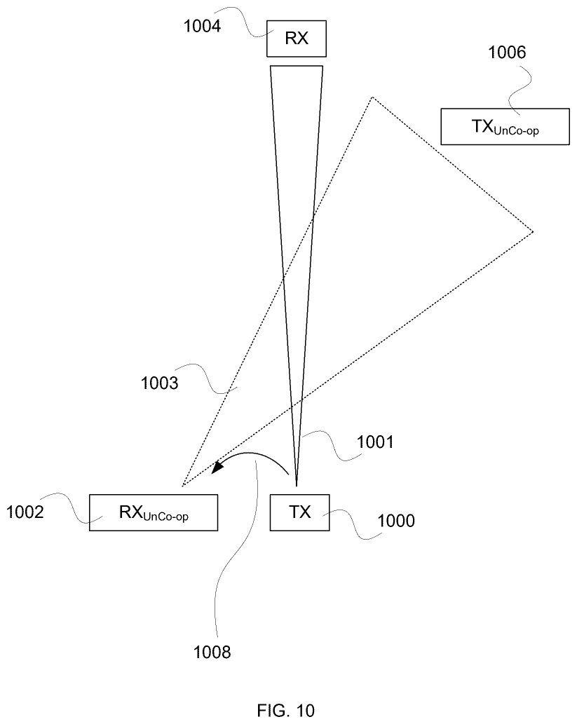

FIG. 10 is a diagram illustrating an embodiment of a system using angular division duplexing. In some embodiments, the system of FIG. 10 implements an antenna usage for the systems of FIG. 2, 3, 4, or 5. In the example shown, transmitter (e.g., TX 1000) using narrow beams (e.g., narrow transmitter beam 1001) with very low power outside of the primary beam (e.g. sidelobe power) can operate with a non-cooperative receiver 1002 with a wide receive beam (e.g., wide receive antenna beam 1003) by emitting low signal power (e.g., power 1008) towards that non-cooperating receiver 1002 such that power 1008 is below the noise floor of non-cooperating receiver 1002. In some embodiments, this is achievable because transmitter 1000 transmits at frequencies above 30 GHz—for example, with a 50 m separation, transmission sidelobes (e.g., from transmitter 1000) are 60 dB below a main beam for a receiver (e.g., non-cooperating receiver 1002) at 4 beamwidths away. In some embodiments, for an omnidirectional antenna for non-cooperative receiver 1002 (e.g., a worst case scenario), the received power at non-cooperative receiver 1002 is PTX−34−55−60=PTX−134 where the noise floor is −203 W/Hz so PTX<−59 dBW/Hz or <1 dBW/MHz (1.25 W/MHz) at +/1 4 beamwidths. So, when beamwidths are <1 degrees, then you only need 4 degrees of separation to coexist.

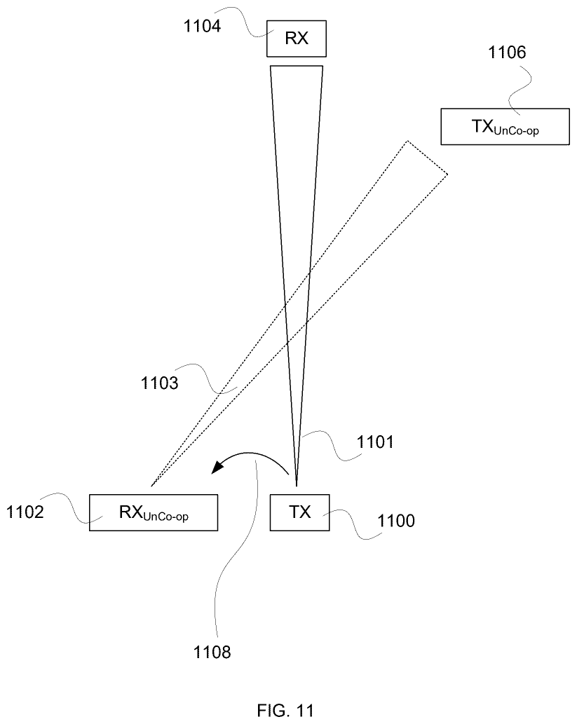

FIG. 11 is a diagram illustrating an embodiment of a system using angular division duplexing. In some embodiments, the system of FIG. 11 implements an antenna usage for the systems of FIG. 2, 3, 4, or 5. In the example shown, transmitter (e.g., TX 1100) using narrow beams (e.g., narrow transmitter beam 1101) with very low power outside of the primary beam (e.g. sidelobe power) can operate with a non-cooperative receiver 1102 with a narrow receive beam (e.g., wide receive antenna beam 1103) by emitting low signal power (e.g., power 1108) towards that non-cooperating receiver 1102 such that power 1108 is below the noise floor of non-cooperating receiver 1102. In some embodiments, this is achievable because transmitter 1100 transmits at frequencies above 30 GHz—for example, with a 50 m separation, transmission sidelobes (e.g., from transmitter 1100) are 30 dB below a main beam for a receiver (e.g., non-cooperating receiver 1102) at 1 beamwidth away. In some embodiments, the received power at non-cooperative receiver 1102 is PTX−34−55−30−30=PTX−134 where the noise floor is −203 W/Hz so PTX<−59 dBW/Hz or <1 dBW/MHz (1.25 W/MHz). So, when beamwidths are <1 degrees, then you only need 1 degree of separation to coexist, which provides 4 times the potential capacity compared to the only-single-sided angular diversity (e.g., FIG. 10).

FIG. 12A is a diagram illustrating an embodiment of a system for antenna nulling. In some embodiments, the communication system with transmitter 1200 and receiver 1204 comprises the satellite communication system of FIG. 2, 3, 4, or 5 with the transmitter being either the satellite, aircraft, or the terminal and the receiver being either the terminal, the aircraft, or the satellite, respectively. In the example shown, coexistence of transmitter 1200 with transmission antenna beam 1201 and receiver 1204 with receive antenna beam 1203 with non-cooperative transmitter 1206 can be achieved by the setting of the antenna array parameters (e.g., weights and phases of each of the receiving elements of an antenna array) of the receiving antenna of receiver 1204 to create a null (e.g., null cone 1207) in the direction of the interfering transmitter (e.g., uncooperative transmitter 1206 communicating with uncooperating receiver 1202) that may create interference. This nulling of the interfering signal exploits the large number of antenna elements that have sufficient flexibility to maintain tight angular tolerances for ADD while providing >20 dB of interference rejection for 1 or more angles (e.g., those angles associated with interfering transmitters).

In some embodiments, a terminal, aircraft, or a satellite or control system such as a software defined network has a stored database of locations of other system terminals and other system satellites and/or an understanding of the carrier frequency used for transmission. This location, frequency information, and/or other data such as topological information can be used to calculate the probability of potential interference of a transmitted signal (e.g., is within a distance that the transmitted signal at its frequency will interfere with a system receiver). A determination can be made as to whether an other system terminal or an other system satellite would generate potential interference to the system's terminal, aircraft, or satellite (e.g., that the other system terminal or satellite transmitter is within a threshold distance of the system receiver or is close enough transmitting the frequency towards the system receiver to cause interference). In response to the other system's device generating potential interference (e.g., being within the distance to cause interference at the frequency), indicating to the antenna to create a null (e.g., a receiving null) to reduce interference between the other system and the system's terminal or satellite. In some embodiments, a terminal, aircraft, or a satellite has a detector for transmissions from other system terminals and other system satellites and an understanding of the carrier frequency used for reception. This detection of an other system and direction that the other system has from the system can be used to calculate potential interference of received signal from the other system. A determination can also be made as to whether an other system terminal or an other system satellite is potentially interfering with the system's terminal, aircraft, or satellite. In response to the other system's device being potentially interfering, indicating to the antenna to create a null (e.g., a receiving null) to reduce interference between the other system and the system's terminal, aircraft, or satellite. In some embodiments, a combination of detection and using a database of stored location information are used in combination to determine whether or not to create a null (e.g., a receiving null) and where or which direction to create a null.

FIG. 12B is a diagram illustrating an embodiment of a system for antenna nulling. In some embodiments, the communication system with transmitter 1200 and receiver 1204 comprises the satellite communication system of FIG. 2, 3, 4, or 5 with the transmitter being either the satellite, aircraft, or the terminal and the receiver being either the terminal, aircraft, or the satellite, respectively. In the example shown, coexistence of transmitter 1210 with transmission antenna beam 1211 and receiver 1214 with receive antenna beam 1213 with non-cooperative receivers (e.g., non-cooperative receiver 1212) can be achieved by the setting of the transmit array parameters (e.g., weights and phases of each of the transmitting elements) of the transmitter to nullform (e.g., null cone 1215) in the direction of non-cooperative receiver 1212 (e.g., a victim receiver) that may be interfered by the transmission of transmitter 1210. This nulling of the transmission signal exploits the large number of elements with sufficient flexibility to maintain tight angular tolerances for ADD while providing >20 dB less of signal power at 1 or more angles (e.g., those angles associated with receivers that the system does not want to deliver any power to).

In some embodiments, a terminal, a satellite, an aircraft, or control systems such as a software defined network has a stored database of locations of other system terminals and other system satellites or an other terrestrial system (e.g., fixed data terminals, mobile bases stations, possible mobile endpoint devices, etc.) and an understanding of the carrier frequency used for transmission and/or reception. This location and frequency information and/or other data such as topological information can be used to calculate a probability of potential interference of a received signal from the system. A determination can be made as to whether an other system terminal or an other system satellite would have a high probability of potential interference from the transmissions of the system's terminal, aircraft, or satellite. In response to the other system's device being subject to potential interference, indicating to the antenna to create a null (e.g., a transmitting null) to reduce interference between the system and the other system's terminal, aircraft, or satellite. In some embodiments, a terminal, aircraft, or a satellite has a detector for transmissions from other system terminals and other system satellites and/or an understanding of the carrier frequency used for reception. This detection of transmissions from an other system and direction that the other system has from the system can be used to calculate potential interference of a transmitted signal from the system. A determination can be made as to whether an other system terminal or an other system satellite is potentially interfered with by the system's terminal, aircraft, or satellite. In response to the system's device being potentially interfering, indicating to the antenna to create a null (e.g., a transmitting null) to reduce interference to the other system from the system's terminal or satellite. In some embodiments, a combination of detection and using a database of stored location information are used in combination to determine whether or not to create a null (e.g., a transmitting null) and where or which direction to create a null.

In some embodiments, coexistence with non-cooperative receivers can be achieved through near-field operations. Large apertures create a highly variable phaser front that is in close proximity with a non-cooperative receiver that incorporates gain through a reflector or array. The lack of a planar phase front reduces the gain of the aperture and thus reduces the signal levels for the transmitter received by the non-cooperative receiver. The far field begins at 2D\hat{ }2/lambda so for D of 0.5 m and lambda of 0.01 m, the far field begins at 50 m. Therefore, the near-field effect can be exploited to enable close proximity. For example, a 40 dBi antenna for an uncooperative receiver would only have an effective 20 dB gain in the nearfield further enhancing coexistence.

In some embodiments, coexistence can be provided by overlaying ADD capabilities with FDD in which spectrum that is not cochannel with the non-cooperative system (receiver) can be used. Two mechanisms can be used: proactive and reactive. The proactive mechanism is the case when the location and band of the noncooperative systems is known. The transmitter in this case exploits the narrow beamwidths and the use of alternative spectrum either via alternate bands or via notching the spectrum used by the noncooperative receiver for the area requiring coexistence. The reactive mechanism is the case when the location is unknown but both the uplink and downlink of the noncooperative communication system is known. The system, using the high gain antennas, detects either side of the transmission (uplink or downlink) and then employs the techniques described in the proactive approach to move away from the frequency that would generate co-channel interference.

FIG. 13 is a diagram illustrating an embodiment of a satellite of a satellite system. In some embodiments, the satellite of FIG. 13 is used for satellite 210, 310, 400, and 500 of satellite system of FIGS. 2, 3, 4, and 5, respectively. In various embodiments, the satellite system comprises a system in a satellite, in an airplane, in an aircraft, in a balloon, in a blimp, or any other appropriate craft. In the example shown, the satellite of FIG. 13 includes a bus section with power generation, storage, and distribution 1300, telemetry, tracking, and control 1302, flight computer and control 1004, Global Navigation Satellite System (GNSS) time sync 1306, Guidance, Navigation, and Control (GNC) and GNC systems 1308, and propulsion 1310. The satellite of FIG. 13 also includes a payload section with optical ISL 1312, RF ISL 1314, fully connected non-blocking switch 1016, constellation time synch & payload time fanout 1318, payload baseband unit: modem bank, radio access network control, and data plane CLI 1320, broadband steerable multibeam RX subsystem(s) 1328, and broadband steerable multibeam TX subsystem(s) 1030.

In some embodiments, the satellite of FIG. 13 includes hardware for operating the satellite. For example, energy is stored and generated by power generation, storage, & distribution 1300, which distributes power to the satellite system. Flight computer and control 1304 provides overall control and coordination of the satellite system including power generation, storage, & distribution 1300. Flight computer and control 1304 is coupled to the other units of the satellite system via a set of connections (e.g., the control fanout). Flight computer and control 1304 is coupled to telemetry, tracking, and control 1302, Global Navigation Satellite System (GNSS) time sync 1306, Guidance, Navigation, and Control (GNC) and GNC systems 1308, and propulsion 1310 for operating the satellite system—for example, these systems relate to establishing and maintaining the satellite position with respect to the earth and other satellites in the constellation of satellites including determining an orbit location, establishing a time reference, operating the propulsion system to adjust location in response to not being at an appropriate location, determining how to adjust the location in response to not being at an appropriate location, and determining when the orbit location is as desired.

In some embodiments, an RF signal is received via broadband steerable multibeam RX subsystem(s) 1328 coupled to antenna(s). In some embodiments, each of broadband steerable multibeam RX subsystem(s) 1328 is coupled to a separate antenna. In some embodiments, a set of broadband steerable multibeam RX subsystem(s) 1328 are coupled to a single antenna. The radio frequency signal is processed using a broadband steerable multibeam RX subsystem(s) 1328, wherein the processing includes one or more of: amplifying, filtering, synchronization, correlating, timing, doppler adjusting, de-spreading, de-chirping, and de-hopping. In some embodiments, broadband steerable multibeam RX subsystem(s) 1328 performs one or more of the following processing steps: deinterleaving, demodulation, and error correction coding (ECC) decoding to generate a raw data stream. The raw data stream is passed along to Payload Baseband Unit: Modem Bank, Radio Access Network Control, and Data Plane CLI 1320. In some embodiments, Payload Baseband Unit: Modem Bank, Radio Access Network Control, and Data Plane CLI 1320 processing includes decryption of the raw data stream to generate a decrypted data stream.

In various embodiments, the decrypted data stream comprises one or more of system authentication data, command data, communication data, or any other appropriate data. In some embodiments, decrypted data is passed along path 1334 to fully connected non-blocking switch 1316. Data can be sent off satellite by sending the data to other satellites (e.g., via RF ISL 1314 and Optical ISL 1312) or back down to earth (e.g., via broadband steerable multibeam TX subsystem(s) 1330).

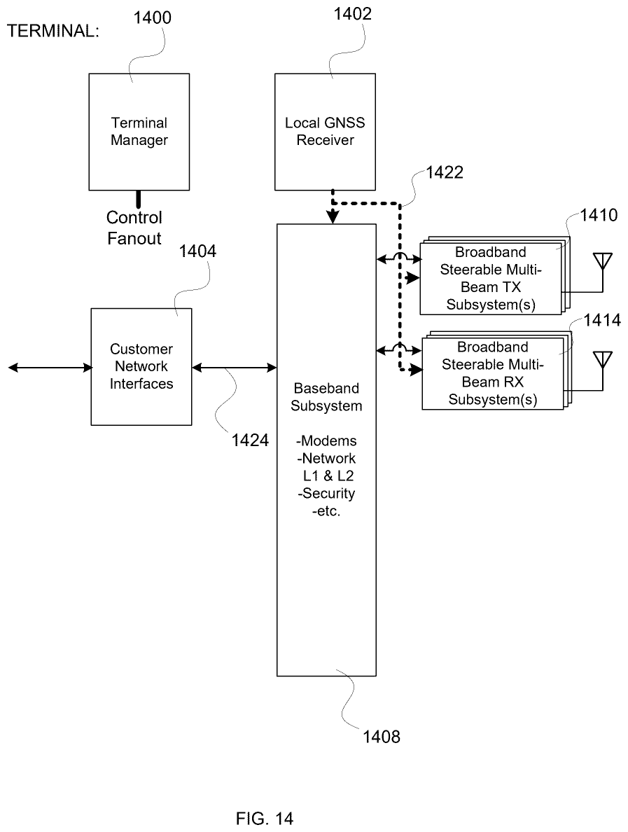

FIG. 14 is a diagram illustrating an embodiment of a terminal of a satellite system. In some embodiments, the terminal of FIG. 14 is used for terminal 216, 316, 406, and 506 of satellite system of FIGS. 2, 3, 4, and 5. In the example shown, the terminal includes terminal manager 1400, local GNSS Receiver 1402, customer network interfaces 1404, baseband subsystem 1408 (e.g., including modems, network L1 & L2, security, etc.), zero or more broadband steerable multibeam RX subsystem(s) 1412, and zero or more broadband steerable multibeam TX subsystem(s) 1410.

In various embodiments, a terminal is configured for specific functionality: receiving and/or sending high bandwidth data.

In some embodiments, a terminal that has functionality of zero or more broadband steerable multibeam RX subsystem(s) 1412 for receiving high bandwidth data and zero or more broadband steerable multibeam TX subsystem(s) 1410 for sending high bandwidth data.

In some embodiments, an RF signal is received via broadband steerable multibeam RX subsystem(s) 1412 coupled to antenna(s). In some embodiments, each of broadband steerable multibeam RX subsystem(s) 1412 is coupled to a separate antenna. In some embodiments, a set of broadband steerable multibeam RX subsystem(s) 1412 are coupled to a single antenna. The radio frequency signal is processed using a broadband steerable multibeam RX subsystem(s) 1412, wherein the processing includes one or more of: amplifying, filtering, synchronization, correlating, timing, doppler adjusting, de-spreading, de-chirping, and de-hopping. In some embodiments, broadband steerable multibeam RX subsystem(s) 1412 performs one or more of the following processing steps: deinterleaving, demodulation, and error correction coding (ECC) decoding to generate a raw data stream. The raw data stream is passed along to Baseband Subsystem 1408. In some embodiments, Baseband Subsystem 1408 processing includes decryption of the raw data stream to generate a decrypted data stream.

In various embodiments, the decrypted data stream comprises one or more of system authentication data, command data, communication data, or any other appropriate data. Data can be sent off terminal by sending the data to other satellites (e.g., via broadband steerable multibeam TX subsystem(s) 1410).

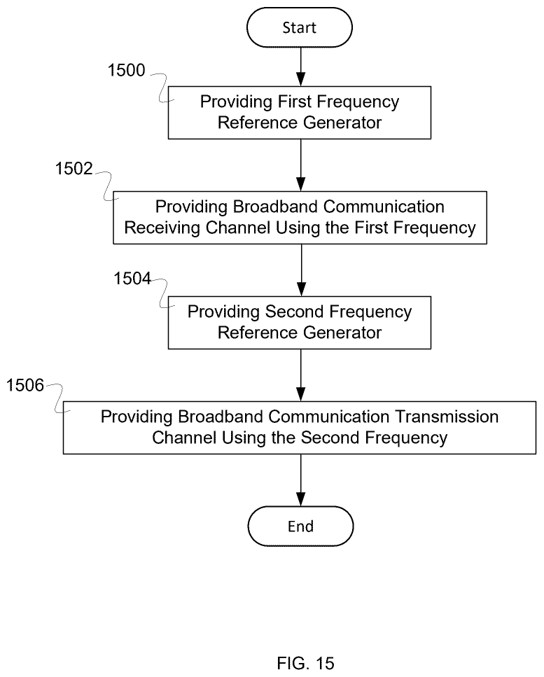

FIG. 15 is a flow diagram illustrating an embodiment of a process for a satellite system. In some embodiments, the process of FIG. 15 is associated with a satellite or aircraft system (e.g., satellite system 210 of FIG. 2, satellite system 310 of FIG. 3, satellite system 400 of FIG. 4, and/or satellite system 500 of FIG. 5). In the example shown, in 1500 a first frequency reference generator is provided. In some embodiments, the first frequency reference generator generates a first frequency reference signal in a first frequency band. In various embodiments, the first frequency band is higher than 10 GHz, the first frequency band is higher than 20 GHz, or any other appropriate frequency band. In 1502, a broadband communication receiving channel is provided using the first frequency. For example, the satellite or aircraft of the satellite system receives data using a signal in the first frequency band, which is a reverse of a legacy satellite system that includes a legacy communication transmission channel for transmitting data from a legacy satellite in the first frequency band. In some embodiments, the broadband communication receiving channel comprises a broadband channel (e.g., 1,000 MHz, 500 MHz, 320 MHz of the 3.45 GHz band within the frequency range of 20.1-23.55 GHz).

In some embodiments, the satellite system uses the frequency band 27-30 GHz for satellite to earth communications.

In some embodiments, the satellite system uses the frequency band 40-42 GHz for satellite to earth communications.

In some embodiments, the satellite system uses the frequency band 47-52 GHz for satellite to earth communications.

In some embodiments, the legacy satellite system uses the frequency band 17-20 GHz for satellite to earth communications.

In some embodiments, the legacy satellite system uses the frequency band 20-24 GHz for satellite to earth communications.

In some embodiments, the legacy satellite system uses the frequency band 37.5-42.5 GHz for satellite to earth communications.

In 1504, a second frequency reference generator is provided. In some embodiments, a second frequency reference generator generates a second frequency reference signal in a second frequency band. In various embodiments, the second frequency band is higher than 10 GHz, the second frequency band is higher than 20 GHz, or any other appropriate frequency band. In 1506, a broadband communication transmission channel is provided using the second frequency. For example, the satellite or aircraft system transmits using the second frequency, which is a reverse of a legacy satellite system that includes a legacy communication receiving channel for receiving data at the legacy satellite in the second frequency band. In some embodiments, the broadband communication transmission channel comprises a broadband channel (e.g., 1,000 MHz, 500 MHz, 320 MHz of the 3.35 GHz band within the frequency range of 20.2-23.55 GHz).

In some embodiments, the satellite system uses the frequency band 17-20 GHz for earth to satellite communications.

In some embodiments, the satellite system uses the frequency band 20-24 GHz for earth to satellite communications.

In some embodiments, the satellite system uses the frequency band 37.5-42.5 GHz for earth to satellite communications.

In some embodiments, the legacy satellite system uses the frequency band 27-30 GHz for earth to satellite communications.

In some embodiments, the legacy satellite system uses the frequency band 40-42 GHz for earth to satellite communications.

In some embodiments, the legacy satellite system uses the frequency band 47-52 GHz for earth to satellite communications.

In some embodiments, the satellite system further comprises a receiving antenna, wherein the broadband communication receiving channel for receiving broadband data uses the receiving antenna. In some embodiments, the satellite system further comprises a transmission antenna, wherein the broadband communication transmission channel for transmitting broadband data uses the transmission antenna.

In some embodiments, the system further comprises a receiving pencil beam antenna, wherein the broadband communication receiving channel for receiving broadband data uses the receiving pencil beam antenna. In some embodiments, the receiving pencil beam antenna comprises an antenna capable of forming a central beam with a half width of less than 5 degrees. In various embodiments, the receiving pencil beam antenna comprises a beamformed antenna, a phased-array antenna, a metamaterial antenna, an RF lens, or any other appropriate antenna or combination of antennas. In some embodiments, the receiving pencil beam antenna is configured to receive multiple beams simultaneously. In some embodiments, the receiving pencil beam antenna forms a null to reduce signal degradation from an interfering signal.

In some embodiments, the system further comprises a transmission pencil beam antenna, wherein the broadband communication transmission channel for transmitting broadband data uses the transmission pencil beam antenna. In some embodiments, the transmission pencil beam antenna comprises an antenna capable of forming a central beam with a half width of less than 5 degrees. In various embodiments, the transmission pencil beam antenna comprises a beamformed antenna, a phased-array antenna, a metamaterial antenna, an RF lens, or any other appropriate antenna or combination of antennas. In some embodiments, the transmitting pencil beam antenna is configured to transmit multiple beams simultaneously. In some embodiments, the transmission pencil beam antenna forms a null to reduce transmission towards a known receiver.

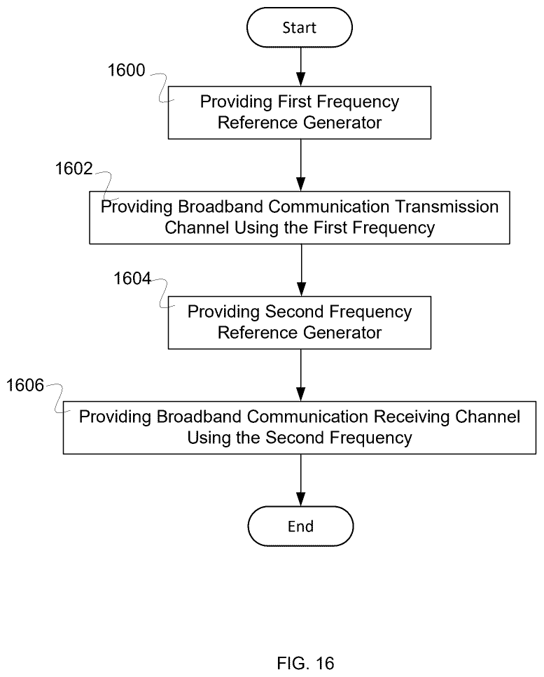

FIG. 16 is a flow diagram illustrating an embodiment of a process for a satellite system. In some embodiments, the process of FIG. 16 is associated with a satellite or aircraft system (e.g., satellite system 210 of FIG. 2, satellite system 310 of FIG. 3, satellite system 400 of FIG. 4, and/or satellite system 500 of FIG. 5). In the example shown, in 1600 a first frequency reference generator is provided. In some embodiments, the first frequency reference generator generates a first frequency reference signal in a first frequency band. In various embodiments, the first frequency band is higher than 10 GHz, the first frequency band is higher than 20 GHz, or any other appropriate frequency band. In 1602, a broadband communication transmission channel is provided using the first frequency. For example, the terminal of the satellite system transmits data using a signal in the first frequency band, which is a reverse of a legacy satellite system that includes a legacy communication receiving channel for receiving data from a legacy satellite in the first frequency band. In some embodiments, the broadband communication receiving channel comprises a broadband channel (e.g., 1,000 MHz, 500 MHz, 320 MHz of the 3.35 GHz band within the frequency range of 20.2-23.55 GHz).

In some embodiments, the satellite system uses the frequency band 27-30 GHz for satellite to earth communications.

In some embodiments, the satellite system uses the frequency band 40-42 GHz for satellite to earth communications.

In some embodiments, the satellite system uses the frequency band 47-52 GHz for satellite to earth communications.

In some embodiments, the legacy satellite system uses the frequency band 17-20 GHz for satellite to earth communications.

In some embodiments, the legacy satellite system uses the frequency band 20-24 GHz for satellite to earth communications.

In some embodiments, the legacy satellite system uses the frequency band 37.5-42.5 GHz for satellite to earth communications.

In 1604, a second frequency reference generator is provided. In some embodiments, a second frequency reference generator generates a second frequency reference signal in a second frequency band. In various embodiments, the second frequency band is higher than 10 GHz, the second frequency band is higher than 20 GHz, or any other appropriate frequency band. In 1606, a broadband communication receiving channel is provided using the second frequency. For example, the terminal system receives using the second frequency, which is a reverse of a legacy satellite system that includes a legacy communication transmission channel for receiving data at the legacy satellite in the second frequency band. In some embodiments, the broadband communication receiving channel comprises a broadband channel (e.g., 1,000 MHz, 500 MHz, 320 MHz of the 3.35 GHz band within the frequency range of 20.2-23.55 GHz).

In some embodiments, the satellite system uses the frequency band 17-20 GHz for earth to satellite communications.

In some embodiments, the satellite system uses the frequency band 20-24 GHz for earth to satellite communications.

In some embodiments, the satellite system uses the frequency band 37.5-42.5 GHz for earth to satellite communications.

In some embodiments, the legacy satellite system uses the frequency band 27-30 GHz for earth to satellite communications.

In some embodiments, the legacy satellite system uses the frequency band 40-42 GHz for earth to satellite communications.

In some embodiments, the legacy satellite system uses the frequency band 47-52 GHz for earth to satellite communications.

In some embodiments, the satellite system further comprises a receiving antenna, wherein the broadband communication receiving channel for receiving broadband data uses the receiving antenna. In some embodiments, the satellite system further comprises a transmission antenna, wherein the broadband communication transmission channel for transmitting broadband data uses the transmission antenna.

In some embodiments, the system further comprises a receiving pencil beam antenna, wherein the broadband communication receiving channel for receiving broadband data uses the receiving pencil beam antenna. In some embodiments, the receiving pencil beam antenna comprises an antenna capable of forming a central beam with a half width of less than 5 degrees. In various embodiments, the receiving pencil beam antenna comprises a beamformed antenna, a phased-array antenna, a metamaterial antenna, an RF lens, or any other appropriate antenna or combination of antennas. In some embodiments, the receiving pencil beam antenna is configured to receive multiple beams simultaneously. In some embodiments, the receiving pencil beam antenna forms a null to reduce degradation from an interfering signal.

In some embodiments, the system further comprises a transmission pencil beam antenna, wherein the broadband communication transmission channel for transmitting broadband data uses the transmission pencil beam antenna. In some embodiments, the transmission pencil beam antenna comprises an antenna capable of forming a central beam with a half width of less than 5 degrees. In various embodiments, the transmission pencil beam antenna comprises a beamformed antenna, a phased-array antenna, a metamaterial antenna, an RF lens, or any other appropriate antenna or combination of antennas. In some embodiments, the transmitting pencil beam antenna is configured to transmit multiple beams simultaneously. In some embodiments, the transmission pencil beam antenna forms a null to reduce transmission towards a known receiver.

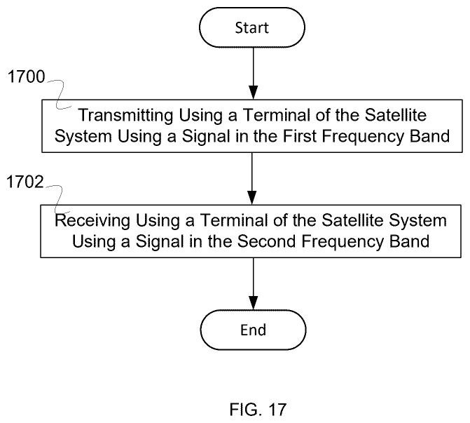

FIG. 17 is a flow diagram illustrating an embodiment of a process for a satellite system. In some embodiments, the process of FIG. 17 is associated with a satellite system (e.g., satellite system 210 of FIG. 2, satellite system 310 of FIG. 3, satellite system 400 of FIG. 4, and/or satellite system 500 of FIG. 5). In the example shown, in 1700 the terminal of the satellite system transmits data using a signal in the first frequency band, which is a reverse of a legacy satellite system that includes a legacy communication receiving channel for receiving data from a legacy satellite in the first frequency band. For example, a first frequency reference generator is provided. In some embodiments, the first frequency reference generator generates a first frequency reference signal in a first frequency band. In various embodiments, the first frequency band is higher than 10 GHz, the first frequency band is higher than 20 GHz, or any other appropriate frequency band. In some embodiments, the broadband communication receiving channel comprises a broadband channel (e.g., 1,000 MHz, 500 MHz, 320 MHz of the 3.35 GHz band within the frequency range of 20.2-23.55 GHz).

In some embodiments, the satellite system uses the frequency band 27-30 GHz for satellite to earth communications.

In some embodiments, the satellite system uses the frequency band 40-42 GHz for satellite to earth communications.

In some embodiments, the satellite system uses the frequency band 47-52 GHz for satellite to earth communications.

In some embodiments, the legacy satellite system uses the frequency band 17-20 GHz for satellite to earth communications.

In some embodiments, the legacy satellite system uses the frequency band 20-24 GHz for satellite to earth communications.

In some embodiments, the legacy satellite system uses the frequency band 37.5-42.5 GHz for satellite to earth communications.

In 1702, the terminal system receives using a second frequency, which is a reverse of a legacy satellite system that includes a legacy communication transmission channel for receiving data at the legacy satellite in the second frequency band. For example, a second frequency reference generator is provided. In some embodiments, a second frequency reference generator generates a second frequency reference signal in a second frequency band. In various embodiments, the second frequency band is higher than 10 GHz, the second frequency band is higher than 20 GHz, or any other appropriate frequency band. In some embodiments, the broadband communication receiving channel comprises a broadband channel (e.g., 1,000 MHz, 500 MHz, 320 MHz of the 3.35 GHz band within the frequency range of 20.2-23.55 GHz).

In some embodiments, the satellite system uses the frequency band 17-20 GHz for earth to satellite communications.

In some embodiments, the satellite system uses the frequency band 20-24 GHz for earth to satellite communications.

In some embodiments, the satellite system uses the frequency band 37.5-42.5 GHz for earth to satellite communications.

In some embodiments, the legacy satellite system uses the frequency band 27-30 GHz for earth to satellite communications.

In some embodiments, the legacy satellite system uses the frequency band 40-42 GHz for earth to satellite communications.

In some embodiments, the legacy satellite system uses the frequency band 47-52 GHz for earth to satellite communications.

In some embodiments, the satellite system further comprises a receiving antenna, wherein the broadband communication receiving channel for receiving broadband data uses the receiving antenna. In some embodiments, the satellite system further comprises a transmission antenna, wherein the broadband communication transmission channel for transmitting broadband data uses the transmission antenna.

In some embodiments, the system further comprises a receiving pencil beam antenna, wherein the broadband communication receiving channel for receiving broadband data uses the receiving pencil beam antenna. In some embodiments, the receiving pencil beam antenna comprises an antenna capable of forming a central beam with a half width of less than 5 degrees. In various embodiments, the receiving pencil beam antenna comprises a beamformed antenna, a phased-array antenna, a metamaterial antenna, an RF lens, or any other appropriate antenna or combination of antennas. In some embodiments, the receiving pencil beam antenna is configured to receive multiple beams simultaneously. In some embodiments, the receiving pencil beam antenna forms a null to reduce degradation from an interfering signal.

In some embodiments, the system further comprises a transmission pencil beam antenna, wherein the broadband communication transmission channel for transmitting broadband data uses the transmission pencil beam antenna. In some embodiments, the transmission pencil beam antenna comprises an antenna capable of forming a central beam with a half width of less than 5 degrees. In various embodiments, the transmission pencil beam antenna comprises a beamformed antenna, a phased-array antenna, a metamaterial antenna, an RF lens, or any other appropriate antenna or combination of antennas. In some embodiments, the transmitting pencil beam antenna is configured to transmit multiple beams simultaneously. In some embodiments, the transmission pencil beam antenna forms a null to reduce transmission towards a known receiver.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
transmitting broadband data from a terminal using a broadband communication transmission channel using a first frequency reference signal, wherein a legacy satellite system comprises a legacy communication receiving channel for receiving data from a legacy terminal in a first frequency band, wherein a first frequency reference generator generates a first frequency reference signal in the first frequency band;
receiving broadband data at the terminal using a broadband communication receiving channel using the second frequency reference signal, wherein the legacy satellite system comprises a legacy communication transmission channel for transmitting data at the legacy terminal using a second frequency band, wherein the second frequency reference generator generates a second frequency reference signal in the second frequency band.

2. The method of claim 1, wherein the broadband communication receiving channel for receiving broadband data uses the receiving pencil beam antenna.

3. The method of claim 2, wherein the receiving pencil beam antenna comprises an antenna capable of forming a central beam with a half width of less than 5 degrees.

4. The method of claim 3, wherein the receiving pencil beam antenna comprises one or more of a beamformed antenna, a phased-array antenna, a metamaterial antenna, reflector antenna, or an RF lens.

5. The method of claim 2, wherein the receiving pencil beam antenna is configured to receive multiple beams simultaneously.

6. The method of claim 2, wherein the receiving pencil beam antenna forms one or more nulls to reduce signal degradation from an interfering signal.

7. The method of claim 6, wherein the one or more nulls are determined based at least in part on a distance to a source of the interfering signal and a first frequency.

8. The method of claim 1, wherein the broadband communication transmission channel for transmitting broadband data uses the transmission pencil beam antenna.

9. The method of claim 8, wherein the transmission pencil beam antenna comprises an antenna capable of forming a central beam with a half width of less than 5 degrees.

10. The system of claim 9, wherein the transmitting pencil beam antenna comprises a beamformed antenna, a phased-array antenna, a metamaterial antenna, reflector antenna, or an RF lens

11. The method of claim 8, wherein the transmitting pencil beam antenna is configured to transmit multiple beams simultaneously.

12. The method of claim 8, wherein the transmission pencil beam antenna forms a null to reduce transmission towards a known receiver.

13. The method of claim 12, wherein the null is determined based at least in part on a distance to the known receiver and a second frequency.

14. The method of claim 1, wherein the first frequency band is higher than 10 GHz and the second frequency band is higher than 10 GHz.

15. The method of claim 1, wherein the first frequency band is higher than 20 GHz and the second frequency band is higher than 20 GHz.

16. The method of claim 1, wherein the first frequency band comprises 17-20 GHz and the second frequency band comprises 27-30 GHz.

17. The method of claim 1, wherein the first frequency band comprises 20-24 GHz and the second frequency band comprises 40-42 GHz.

18. The method of claim 1, wherein the first frequency band comprises 37.5-42.5 GHz and the second frequency band comprises 47-52 GHz.

19. The method of claim 1, wherein in response to a request to join a network, the terminal provides the network with a terminal location.

20. The method of claim 1, wherein a satellite or a control system of the network determines whether there is an interference possibility to an other system, wherein the other systems and the other system information is stored in a database.

21. The method of claim 20, wherein in response to determining that there is the interference possibility to the other system, receive an indication for the terminal to use frequencies to lessen interference.

22. The method of claim 20, wherein in response to determining that there is the interference possibility to the other system, receive an indication to generate a null in a direction to lessen interference.

23. The method of claim 20, wherein in response to determining that there is the interference possibility to the other system, receive an indication to deny service to the terminal.

24. The method of claim 20, wherein in response to determining that there is the interference possibility to the other system, receive an indication of a reason for denial of service to the terminal.

25. The method of claim 20, wherein in response to determining that there is the interference possibility to the other system, receive an indication of an alternate location for the terminal.
